(19) United States
(12) Patent Application Publication
(10) Pub. No.: US 2025/0215203 A1
(43) Pub. Date: Jul. 3, 2025

(54) LOW DENSITY PEROXIDE CURED EPDM RUBBER BASED INSULATION AND ITS USE THEREOF IN COMPOSITE ROCKET MOTOR CASING

(71) Applicant: CHAIRMAN, DEFENCE RESEARCH & DEVELOPMENT ORGANISATION, New Delhi (IN)

(72) Inventors: Isaac Kingstone Lesley JABEZ, Hyderabad (IN); Urmila DAS, Hyderabad (IN); Subrahmanya Srinivasa Gopal AVATAPALLI, Hyderabad (IN); Manickavasagam MARUDHANAYAGAM, Hyderabad (IN); Rama Manohara Babu MULAKALURI, Hyderabad (IN)

(73) Assignee: CHAIRMAN, DEFENCE RESEARCH & DEVELOPMENT ORGANISATION, New Delhi (IN)

(21) Appl. No.: 18/848,059

(22) PCT Filed: Mar. 6, 2023
(86) PCT No.: PCT/IN2023/050207

§ 371 Date: Sep. 17, 2024

(30) Foreign Application Priority Data
Mar. 17, 2022 (IN) 202211014898

(51) Int. Cl. C08L 23/16; C08K 3/22; C08K 3/36; F02K 9/34

(52) U.S. Cl. CPC C08L 23/16; C08K 3/22; C08K 3/36; F02K 9/34; C08K 2003/2241

(57) ABSTRACT

The present invention relates to a low density peroxide cured EPDM rubber based insulation suitable for use in large composite rocket motor casing (CRMC), which uses only conventional filler. The said insulation can be used in large CRMC cast with all types of propellants viz., Composite based Solid Propellant, double base solid propellant, NEPE based new generation propellant etc. meeting insulation requirements of large CRMCs, improved thermal properties while retaining the required mechanical properties, having longer shelf life, higher thermal stability and excellent interfacial bonding strength with various interfaces. It also relates to a process for preparing peroxide cured EPDM rubber based insulation.

### FIELD OF INVENTION

The present invention relates to a low density peroxide cured EPDM rubber based insulation and a process of preparation thereof. Particularly, it relates to EPDM insulation compositions for use in large Composite Rocket Motor Casing (CRMC).

### BACKGROUND OF INVENTION

Solid rocket motors typically include an outer casing or case housing a solid propellant grain. During operation, a heat insulating layer or layers (insulation) protects the rocket motor casing from heat and erosion caused by particle streams generated by combustion of the propellant. Typically, the insulation is bonded to the inner surface of the casing and is generally fabricated from a composition that, upon curing, is capable of withstanding the high temperature gases and erosive particles produced while the propellant grain burns. A liner layer (liner) functions to bond the propellant grain to the insulating layer and to any non-insulated portions of the casing. The combustion of solid rocket propellant generates extreme conditions within the rocket motor casing. If the propellant penetrates through the insulation and liner, the casing may melt, causing the rocket motor to fail. Thus, it is crucial that insulation withstands the extreme conditions experienced during propellant combustion and protects the casing from the burning propellant. Also, requirement of low-density insulator is mandatory to reduce the inert weight of the propulsion system.

Sulphur cured EPDM insulation is well known. However, unsaturation being present in the side chain, sulphur curing limits the crosslink density and induces problems with respect to achieving optimum cure, compatibility with new generation propellant containing energetic nitro groups and achieving uniform mechanical properties in all directions. Solution for the above problems lies only in peroxide curing. Peroxide cured EPDM insulation offers several advantages over the sulphur cured EPDM insulation, in terms of mechanical, thermal, ablation/erosion resistance, ageing resistance. However, the problems posed by peroxide curing especially with respect to dispersion of polar peroxides in apolar EPDM matrix leading to discolouration and in-homogeneity in the achieved properties, made it not so popular for insulation of large composite Rocket Motor casing (CRMC).

U.S. Pat. No. 4,501,841 describes 5 different elastomers including EPDM based elastomer, used as a low smoke insulation for rocket motors. The claimed EPDM rubber based formulation comprises of 100 parts EPDM rubber, 15-75 parts poly-aramid pulp, 10-30 parts of hydrated silica and 1-5 parts of peroxide as curing agent. The claimed formulation exhibits tensile strength of 16-39 Mpa, % elongation at break of 10-30 and shore A hardness of 85-95. However, % elongation claimed of this formulation makes it unacceptable for large CRMC. Further, presence of Poly-aramid pulp might impart appreciable hygroscopicity and scatter in mechanical properties and appreciable difference between mechanical properties of warp and weft directions, which are not desirable for large CRMC.

U.S. Pat. No. 5,985,970 describes a formulation of silicone modified EPDM elastomer cured with organic peroxide and the process for production of tack free elastomeric surface. The claimed formulation exhibits tensile strength of 13 Mpa, % elongation of 520 and hardness duro A-47. The composition is used for rubber products like hoses, rubber sheets, roofing sheets, canvas sheets, weather strips, sealing sponge, protector tubes, protector sponges, etc. However, this patent reveals no information on thermal properties & and interface properties. Silicone, in general will exhibit poor bonding. Therefore, it raises skepticism over the bond strength of insulation with the various interfaces encountered during insulation lining of large CRMCs.

U.S. Pat. No. 6,071,996 describes a formulation, which consists of 100 parts of EPDM rubber, 60-700 parts of carbon black as reinforcing filler, 40-175 parts of processing materials and 2-10 parts of sulphur as curing system. The claimed formulation exhibits tensile strength of 4.5-9 MPa and % Elongation of 290-484. The said formulation is used as walkway pad for excellent weather resistance and low temperature flexibility. This patent too does not reveal any information on thermal properties. Further mechanical properties claimed do not meet the insulation requirement of large CRMC. Moreover, the presence of Carbon black as reinforcing filler is unacceptable for insulator of large CRMC as thermal conductivity has to be as low as possible.

Indian patent application 3103/DEL/2005 discloses 3 formulation based on EPDM rubber blended with Hypalon, Neoprene and hypalon Neoprene blend as insulation materials for case bonded solid rocket motors. The claimed formulation consists of 50-130 PHR of EPDM, 10-50 PHR of Hypalon, Neoprene and their blend, 30-50 PHR of fumed silica, 1-2 PHR of sulphur as vulcanizing agent. The said composition exhibits tensile strength of 100-400 kgf/cm², % elongation of 425-1000, density 1-3.5 g/cm³, shore A hardness 70-80, thermal conductivity 0.110-0.330 W/mK, erosion rate 0.01-0.09 mm/sec and peel strength 0.10-3.7 kg/cm. The claimed formulation comprises of Hypalon (which is nothing but chlorosulphonated polyethylene) and sulphur, which will limit its end application only to composite solid propellant and will preclude the end use of insulation for double base propellant and new generation propellant having energetic nitro groups. Further, use of Hypalon increases the density and reduces the flexibility of elastomeric compound, thereby it is less desirable for large CRMC.

Indian patent application 3467/DEL/2005 discloses a formulation for case bonded solid rocket motors consisting of 50-130 PHR of EPDM rubber, 10-70 PHR of liquid EPDM rubber, 30-50 PHR of fumed silica, 5-20 PHR of fibrous filler and 1-2 PHR of sulphur as vulcanizing agent. The said composition exhibits tensile strength of 100-400 kgf/cm², % elongation of 425-1000, density 0.5-3.5 g/cm³, shore A hardness 70-90, thermal conductivity 0.110-0.330 W/mK, erosion rate 0.01-0.09 mm/sec and peel strength 0.10-3.7 kg/cm. The formulation is sulphur cured and has fibrous fillers.

Indian Patent application 974/KOL/2013 describes a formulation of low density EPDM-BIIR blend for light weight rocket motor insulation compound. The formulation consists of 50-100 parts EPDM elastomer, 5-10 parts polyimide, 5-50 parts Bromobutyl rubber, 5-25 parts nanosilica and 0.3-2.0 parts crystex sulphur. The formulation exhibits tensile strength of 60 kg/cm², % Elongation of 743, density 0.99-1.02 g/cm³, hardness 55-60, specific heat 0.5 cal/gm/° C., thermal conductivity 0.21 W/mk, erosion rate 0.17 mm/sec and peel strength 0.6-0.65 kgf/cm. The tensile strength achieved of the claimed formulation is lower than the requirement of insulation materials for large CRMC. Moreover, this formulation comprises nanosilica which is expensive.

US2018265686A1 relates to a precursor composition for rocket insulation, comprising, before curing: EPDM, precipitated silica, magnesium hydroxide, polymerized 1,2-dihydro-2,2,4-trimethylquinoline, a solid chlorinated paraffin, stearic acid, a five carbon petroleum hydrocarbon, a co-agent, and a peroxide. However, this composition involves the use of additional fillers (zinc oxide or magnesium hydroxide or both zinc oxide and magnesium hydroxide) and components like flame retardant, antioxidant. Density claimed by this patent is quite high i.e. 1.05-1.08 g/cm³. It does not disclose on the achieved thermal properties. Further, none of the compositions of this patent meets both tensile strength and % elongation as required by CRMC insulation (Composition which meets tensile strength does not meet % Elongation and vice-versa).

Despite availability of EPDM based insulations for Rocket motors, there is a requirement for development of peroxide cured EPDM insulation which is compatible with new generation NEPE (nitrate ester plasticized polyether) based, conventional composite based and double based propellant, having low density and required mechanical properties, long shelf life, thermal stability while using proven and indigenously available raw-materials and does not use fibrous fillers.

The present inventors have surprisingly developed an efficient peroxide cured EPDM insulation composition which ameliorates the aforesaid shortcomings of the prior art.

### OBJECTS OF THE INVENTION

It is an object of the present invention to overcome the shortcomings of sulphur cured EPDM insulations and develop peroxide cured EPDM insulation, which is versatile for all types of propellant.

It is another object of the present invention to provide an elastomeric insulation for large CRMC, which is solely based on EPDM rubber, without having any need to blend with secondary polymers like hypalon etc.

It is another object of the present invention to provide a low density insulation, suitable for large CRMC, which uses peroxide as curing agent in order to have weight advantage.

It is yet another object of the present invention to provide an elastomeric composition filled with least required quantity of only precipitated silica and does not require the addition of fibrous filler (Kevlar pulp).

It is yet another object of the present invention to provide an elastomeric composition having uniform mechanical properties all across the length of the sheet drawn irrespective of the direction and improved thermal properties (further reduction in thermal conductivity and Co-efficient of thermal expansion & improvement in specific heat capacity).

It is yet another object of the present invention to provide an elastomeric composition having longer shelf life and higher thermal stability.

It is yet another object of the present invention to provide an elastomeric composition which offers required interfacial bonding strength with various interfaces encountered during insulation lining of large CRMC without incorporation of hypalon etc. to impart polarity.

It is yet another object of the present invention to provide a process of preparation of such elastomeric composition, wherein, polar peroxide is completely and uniformly dispersed in apolar EPDM matrix without any discolouration or non-homogeneity.

### SUMMARY OF THE INVENTION

According to an aspect of the present invention there is provided a peroxide cured EPDM rubber based insulation composition.

According to another aspect of present invention there is provided a process for preparing a peroxide cured EPDM rubber based insulation composition.

According to yet another aspect of present invention there is provided a composite rocket motor casing (CRMC) composed of an elastomeric rubber insulation composition.

### BRIEF DESCRIPTION OF THE DRAWINGS

The above and other aspects, features and advantages of certain exemplary embodiments of the present invention will be more apparent from the following description taken in conjunction with the accompanying drawings wherein:

FIG. 1 illustrates Graphical representation of tensile strength claimed of various compositions according to present invention as a function of PHR of Silica.

FIG. 2 illustrates Specimens drawn for Characterization of Rubber Sheet

FIG. 3 illustrates DSC plot of an embodiment according to present invention (Composition-4)

FIG. 4 illustrates TGA plot of an embodiment according to present invention (Composition-4)

FIG. 5 illustrates Photographic image of rubber mixing/compounding for one of the claimed compositions

FIG. 6 illustrates Photographic image of extrusion of rubber sheet for one of the claimed compositions

### DETAILED DESCRIPTION OF THE INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the scope of the invention as defined by the appended claims and their equivalents.

It is to be understood that the singular forms “a,” “an,” and “the” include plural referents unless the context clearly dictates otherwise.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, steps or components but does not preclude the presence or addition of one or more other features, steps, components or groups thereof.

The term “phr” as used herein means parts per hundred rubber.

The term “CRMC” as used herein means composite rocket motor casing.

The term “EPDM” as used herein means ethylene propylene diene terpolymer (M refers to polymers having saturated backbone and does not stand for Monomer). “Liquid EPDM” means EPDM terpolymer that is flowable at room temperature.

The term “vulcanization/compounding” as used herein means a chemical process in which rubber is heated with curator, activator and accelerator. The process involves the formation of cross-links between rubber molecules so as to achieve improved elasticity, resilience, tensile strength, viscosity, hardness and weather resistance.

The present invention relates to a low density peroxide cured EPDM rubber based insulation and a process of preparation thereof. The present invention pertains to a low density insulation composition for large CRMC, which consists of EPDM terpolymer, precipitated silica as reinforcing filler and peroxide as curing agent. The present invention also covers the process for production of rubber compound towards insulation lining of CRMC.

A large composite rocket motor casing (CRMC) has to exhibit reliable performance over the burning time which is as long as 90-100 Sec. The insulation of large CRMC is expected to fulfil the following requirements.
i. The tensile strength in both warp and weft direction should be 100 kg/cm² (minimum) and % Elongation in both warp and weft direction should be 600 (minimum).
ii. Thermal conductivity at 80° C. should be 0.27 W/m° K (maximum), Specific heat at 80° C. should be 1.46 KJ/Kg (minimum) and Co-efficient of linear thermal expansion should be 3.0×10⁻⁴/° C. (maximum).
iii. The erosion rate at 300 W/cm² heat flux should be as low as possible, preferably less than 0.20 mm/sec. Heat of ablation should be at least 16 MJ/Kg (16-18 MJ/Kg).
iv. Insulation should exhibit good interfacial bonding strength as measured in terms of peel strength. Peel strength between composite to Rubber should be 5 kg-f/cm (minimum), Rubber to Rubber should be 2 kg-f/cm (minimum) and Rubber to Propellant should be 0.6 kg-f/cm (minimum).
v. Insulation should be less hygroscopic.
vi. Insulation should have higher thermal stability, higher ageing resistance & longer shelf life.

The present invention provides low density peroxide cured EPDM rubber based insulation The present invention describes the formulation wherein optimized quantity of silica has been used, which helps to keep the density as low as 0.99 g/cm³ and improve the thermal properties while retaining the required mechanical properties. Further, the formulation gives low erosion rate without using Kevlar pulp (fibrous filler), having only conventional precipitated silica as filler, meeting insulation requirements of large CRMCs and having good compatibility with new generation propellant. Moreover, keeping in view of indigenous availability of large quantity of silica with consistent quality, the present invention uses readily available precipitated silica.

The present invention also provides a process for production of rubber compound towards lining of large CRMC. In an embodiment, the process covers novel methodology for addition of peroxide in order to yield 7 meter long, 600 mm wide and 2 mm thick continuous sheet, which has smooth finish and uniform properties both in warp and weft direction across its entire length. Required quantity of insulation for large CRMC can be realized in number of 10 kg batches blended together and extruded into sheets.

The present invention provides an elastomeric rubber insulation composition for composite rocket motor casing (CRMC) comprising:
(i) Solid ethylene propylene diene terpolymer (EPDM) rubber ranging from 80 to 95 phr;
(ii) Liquid EPDM ranging from 5 to 20 phr;
(iii) Precipitated silica filler ranging from 20 to 50 phr;
(iv) Peroxide curing agent ranging from 1 to 10 phr and;
(v) Additives.

In an embodiment, the peroxide curing agent is selected from Dicumyl Peroxide (DCP), di-tert-butyl-peroxide (DTBP), 1,1-di-(t-butylperoxy)-3,3,5-trimethylcyclohexane, 1,1-di-(t-butylperoxy)-3,3,5-trimethylcyclohexane.

In an embodiment, the additives are selected from 5 to 25 phr process oil, 5 to 25 phr Aromatic polyether based tackifier, 1 to 5 phr plasticizer and process aids, 0.5 to 5 pigment and 2 to 6 phr curing co-agents.

In an embodiment, the process oil is selected from Naphthenic Oil.

In an embodiment, the tackifier is selected from Aromatic polyether, wingtack-95, Vulkanol FH, aliphatic resin, and the like. In an embodiment, the Plasticizer and Process aids are selected from Polyethylene glycol (PEG), Di-octyl Phthalate (DOP), Diethylene Glycol (DEG), Stearic Acid, and the like.

In an embodiment, the pigment is selected from titanium dioxide (TiO₂).

In an embodiment, the curing co-agents are selected from Zinc Dimethacrylate (ZDMA), trimethylolpropane trimethacrylate, high vinyl poly (butadiene) and the like.

In an embodiment, density of the EPDM insulation ranges from 0.996 to 1.055 g/cm³.

In an embodiment, said composition is free of fibrous fillers and non-EPDM polymers.

The present invention also provides a process for preparing an elastomeric rubber insulation composition comprising the steps of:
I. Pre-mixing the components of solid EPDM, liquid EPDM, precipitated silica filler, process oil, a portion of Aromatic polyether based tackifier, Plasticizer and Process aids, and pigment;
II. Final mixing of the rubber mass obtained at step (I) with a dissolved solution of peroxide curing agent, curing co-agent and the remaining portion of tackifier;
III. Curing the rubber mixture of step (II) at 140-150° C. to obtain the elastomeric rubber insulation composition;
   Wherein the ratio of tackifier added at step (I) premixing to Step (II) final mixing is about 70:30 by weight.

### Advantages of Present Invention

Compositions/formulations and processing technology for peroxide cured EPDM insulation suitable for large CRMC have been successfully developed.
Present Invention has done away with fibrous fillers (Kevlar/Poly-aramid pulp) which makes the invented compositions suitable for extrusion so as to achieve accurate control on the achieved thicknesses of the sheets prepared for the insulation lining of large CRMC.
Novel methodology of peroxide addition in the compositions invented, ensures uniform and homogenous dispersion of peroxide, thereby makes the way clear for the implementation of peroxide cured EPDM insulation for large CRMC.
Example Composition-4 of the invention is the first ever developed low density insulation under peroxide curing category. It is capable of achieving low density of 0.996-0.998 g/cm³ only with the help of readily available precipitated silica. Thus the present invention clears the way for mass production of insulation for large CRMC.
Compositions of the present invention offer the required interfacial bonding strength with various interfaces viz. Composite-Rubber, Rubber-Rubber and Rubber-Propellant encountered during the insulation lining of CRMC, without having any need to add polar polymers viz. Hypalon (Chlorosulphonated polyethylene). The above characteristic, in turn, has elevated the peroxide cured EPDM insulations of the present invention as versatile insulation for large CRMC to be cast with propellant of all types viz., Composite based Solid Propellant, double base solid propellant, NEPE based new generation propellant etc.
Peroxide cured EPDM insulation of present invention has low glass transition temperature i.e. will have very good low temperature flexibility thereby widen its scope to be used as insulation for rocket motors which need to be operated under low temperature conditions.
Longer shelf life (4 months) and extrudability of present composition offer very high flexibility for mass production.
Peroxide cured EPDM insulation of present invention exhibits good thermal stability. Composition-4 of present invention has thermal stability up to 420° C. as per DSC and 400° C. as per TGA.

### EXAMPLES

The following examples are meant to illustrate the present invention. The examples are presented to exemplify the invention and are not to be considered as limiting the scope of the invention.

### Example-1

### Preparation of EPDM Composition According to Present Invention

Four different peroxide cured EPDM insulation compositions were developed. All these compositions use solid EPDM terpolymer and liquid EPDM as base rubber, Ultrasil VN-3 based precipitated silica as reinforcing filler, Rubber oil, plasticizer, aromatic polyether based tackifier, TiO₂ and suitable peroxide and co-agent. All the four formulations/compositions differ only by the PHR of silica. The formulations are given in Table-1.

TABLE 1
Compositions

| | Composition in PHR | | | |
|---|---|---|---|---|
| Ingredients | 1 | 2 | 3 | 4 |
| Solid EPDM | 80-95 | 80-95 | 80-95 | 80-95 |
| Liquid EPDM | 5-20 | 5-20 | 5-20 | 5-20 |
| Precipitated Silica | 43-50 | 36-42 | 28-34 | 20-26 |
| Naphthenic Oil | 5-25 | 5-25 | 5-25 | 5-25 |
| Aromatic polyether based | 5-25 | 5-25 | 5-25 | 5-25 |
| tackifier | | | | |
| Plasticizer & Process aids | 1-5 | 1-5 | 1-5 | 1-5 |
| TiO₂ | 0.5-5 | 0.5-5 | 0.5-5 | 0.5-5 |
| Peroxide | 1-10 | 1-10 | 1-10 | 1-10 |
| Co-agent | 2-6 | 2-6 | 2-6 | 2-6 |

### Mixing/Compounding Process Details:

Compounding of rubber using compositions/formulation-1, 2, 3 and 4 was carried out using counter rotating two roll mill of capacity 15 kg. During the entire mixing process, the gap between the rolls was adjusted within 0.1-2 mm in order to ensure proper squeezing, band formation, blending and mixing. Chilled water (temperature 15-20° C.) circulation was kept on during the entire mixing process in order to ascertain that the surface temperature of rubber mass being mixed, did not exceed 60-65° C. in any point of time during mixing.

Mixing was carried out in two phases viz. premixing and final mixing. During premixing, all ingredients except peroxide and co-agent were added and mixed together. During final mixing, peroxide and co-agent were added.

During premixing, solid EPDM was masticated in the two roll mill in order to obtain band of rubber. Thereafter, Liquid EPDM was added and blending of solid and liquid EPDM was accomplished. This was followed by the gradual addition of precipitated silica with the simultaneous incorporation of naphthenic oil, part quantity of tackifier 70% by weight, plasticizer and process aid such that processing difficulty is overcome and homogenous dispersion of silica in the EPDM matrix is ensured; Thereafter, TiO₂ is added and mixing is continued with gradually decreasing the gap between the rollers so that best possible homogeneity is achieved during premixing.

Adequate time gap is given between premixing and final mixing. Time gap recommended is at least 3-4 hours and preferably 12-16 hours. Humidity control of the mixing facility must be ensured. % Relative humidity must be within 50-60%.

During final mixing, the rubber mass is squeezed between the rolls, till the plasticity and smoothness set in. Entire final mixing is carried out under chilled water circulation through the rolls such that at no point of time, temperature of the rubber mass exceeds 65° C.

The present invention provides an innovative methodology adopted to incorporate peroxide, wherein, peroxide is dissolved in part quantity of one of the liquid ingredients and added as a solution into the rubber mass. This gave breakthrough in the dispersion issue posed by peroxide, whereby, EPDM sheets subsequently drawn used to develop discolored patches and non-uniform properties across the length and warp and weft directions. Because of incorporation of peroxide in this manner, discoloration issue is totally overcome and complete and uniform dispersion of peroxide in the rubber matrix is achieved. Thus this invention paves way for the implementation of peroxide cured EPDM based insulation (EPDM-P) in large CRMC.

After incorporation of peroxide as described above, co-agent is added and balance quantity of tackifier about 30% by weight is also added and mixing is continued. Thereafter, sheet of required thickness is drawn by feeding the rubber into the extruder.

Another significant achievement of the invention is overcoming the dryness of the rubber mass after incorporation of peroxide and co-agent by adding part quantity of tackifier (left behind after premixing). This led to the extrusion of sheets having smooth surface finish.

### Example-2

### Characterization of EPDM Composition

MDR data generated of the compositions in Table-1, confirm that curing is completed within 4 hours at 140° C., 2 hours at 150° C. At temperatures below 140° C., say 130° C., 125° C. and 120° C., curing does not go to completion even for prolonged keeping up to 6 hours at 130° C. 8 hours at 125° C. and 8 hours at 120° C. Therefore, mechanical properties were evaluated of composition in Table-1 at 140° C./4 hrs. Physical, mechanical properties claimed of various compositions/formulation are detailed in Table-2, against the insulation requirements of large CRMC.

TABLE 2
Physical & Mechanical Properties of Compositions

| | | | | | Insulation |
|---|---|---|---|---|---|
| | | | | | requirements |
| | Values of Compositions | | | | of large |
| Property | 1 | 2 | 3 | 4 | CRMC |
| Shore-A | 65-68 | 64-67 | 57-59 | 48-53 | For record |
| Hardness | | | | | purpose |
| Density | 1.042-1.055 | 1.020-1.040 | 1.009-1.016 | 0.996-0.998 | As low as |
| (g/cm³) | | | | | possible |
| Tensile | 167.0-195.4 | 168.4-192.0 | 169.4-183.0 | 131.7-164.7 | 100 kg/cm² |
| Strength | | | | | (minimum) |
| (kg/cm²) | | | | | |
| % | 649-694 | 622-653 | 655-676 | 606-654 | 600% |
| Elongation | | | | | (minimum) |

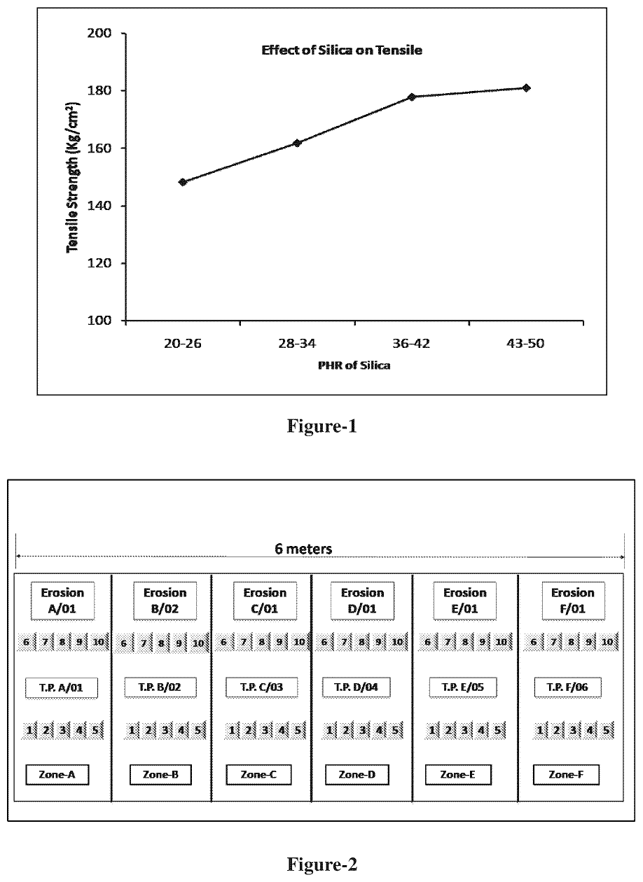

FIG. 1 illustrates Graphical representation of tensile strength claimed of various compositions as a function of PHR of Silica.

Thermal conductivity of the claimed compositions 1 to 4 range from 0.213 W/m-° K of 4^{th} formulation and 0.251 W/m-° K of 1^{st} formulation; Thermal conductivity is the highest for composition 1 and the least for composition-4. Similarly, Specific heat at 80° C. for the various compositions is within 1.84 to 2.09 KJ/Kg-OK and it is the highest for composition-4. Coefficient of thermal expansion is within insulation requirement for large CRMC and it is the least for composition-4 (2.6×10⁻⁴/° K). Glass transition temperature Tg of the claimed formulations are within −46° C. to −55° C.

Erosion rate and heat of ablation claimed of various compositions under invention are detailed in Table-3.

TABLE 3
Erosion Rate and Heat of Ablation of Compositions

| | Claimed values of Compositions | | | |
|---|---|---|---|---|
| Property | 1 | 2 | 3 | 4 |
| Erosion rate at | 0.14-0.17 | 0.15-0.18 | 0.22-0.26 | 0.16-0.17 |
| 300 W/cm² | | | | |
| heat flux | | | | |
| (mm/Sec) | | | | |
| Heat of | 15.94-18.72 | 14.39-17.70 | 11.66-13.86 | 16.22-18.66 |
| ablation | | | | |
| (MJ/Kg) | | | | |

In view of lowest density, lowest thermal conductivity, lowest CTE and highest specific heat among all four compositions, composition-4 is found to be the most lucrative as its other properties too meet the insulation requirements of large CRMC. Therefore, confirmatory 10 kg level trial was carried out using composition-4, in order to check its producibility to meet the quantity requirement for insulation lining of large CRMC.

All the properties achieved of this trial too fall within the values claimed under composition-4 in Table-2 and 3. Sheet of approximately 6 meter length and approximately 630 mm width was drawn by extrusion at the end of this trial, which is represented schematically in FIG. 2. It was divided into 6 Zones.

Specimens for mechanical properties (10 Nos from each zone, shown in blue colour), Thermal properties (T.P) and interface properties were drawn from each zone. Test results of Mechanical properties and Thermal properties are given in Table-4.

TABLE 4
Mechanical & Thermal properties of Confirmatory
10 Kg level trial using composition-4

| | | Insulation |
|---|---|---|
| | Values of | requirements of |
| Property | Composition | large CRMC |
| Shore-A Hardness | 48-53 | For record |
| | | purpose |
| Density (g/cm³) | 0.996-0.998 | As low as |
| | | possible |
| Tensile Strength (kg/cm²) | 131.7-164.7 | 100 kg/cm² |
| | | (minimum) |
| % Elongation | 606-654 | 600% |
| | | (minimum) |
| Thermal conductivity at | 0.213-0.218 | 0.27 |
| 80° C. (W/m-° K) | | (max) |
| Specific Heat at 80° C. | 2.05-2.09 | 1.46 |
| (KJ/Kg-° K) | | (min) |
| Co-efficient of Thermal | 2.3 × 10⁻⁴ to | 3.0 × 10⁻⁴ |
| Expansion (/° K) | 2.6 × 10⁻⁴ | (max) |
| Glass Transition | −48 to −49 | As low as |
| Temperature (T_{g}) (° C.) | | possible |
| Erosion rate at 300 W/cm² | 0.16-0.17 | 0.2 |
| heat flux (mm/Sec) | | (Max) |
| Heat of ablation (MJ/Kg) | 16.22-18.66 | 16.0 |
| | | (Min) |

Interface properties evaluated in terms of peel strength of EPDM sheet of composition-4, schematically shown in FIG. 2 of various interfaces encountered during insulation lining of large CRMC are given in Table-5 against the insulation requirements of large CRMC.

TABLE 5
Interface Properties of Confirmatory
10 kg level trial using Composition-4

| | | | Insulation |
|---|---|---|---|
| | | Values of | requirements |
| | | Composi- | of large |
| Interface | Bonding Agent | tion-4 | CRMC |
| Composite | Chemlok 205, | 6.26-6.99 | 5.0 (min) |
| (CRMC) - | Chemlok 238 & | | |
| Rubber | *Solution of EPDM | | |
| (kg-f/cm) | rubber in Toluene | | |
| Rubber - Rubber | *Solution of EPDM | 4.30-4.88 | 2.0 (min) |
| (kg-f/cm) | rubber in Toluene | | |
| Rubber - HTPB | Bonding agent based | 1.03-1.09 | 0.6 (min) |
| based composite | on HTPB | | |
| solid | | | |
| propellant | | | |
| (kg-f/cm) | | | |

*Uncured rubber compound from each composition/formulation is soaked in toluene overnight with intermittent stirring in order to obtain rubber solution having % solid/Non-volatile matter content of 20-25% and viscosity of 20,000-23,000 Cps at 30° C.

Variations in test results are well within the requirements of insulation. Thus composition-4 and its processing technology is validated against the insulation requirements of large CRMC and also production point of view.

Extrusion of continuous defect free sheet of length about 6 Metres (and of required width and thickness by using die of appropriate dimension), from Composition-4 has been proven. Another salient feature of composition-4 of present invention is that it has shelf life as long as 5 months. Mechanical and Interface properties of composition-4, as tested 1 month after production (with the marginal addition of tackifier while keeping its PHR within the range claimed in Table-1) and 5 months after production, are given in Table-6. Even though, marginal reduction in seen, all the values are within the acceptability limit of large CRMC insulation. Further the uncured rubber retains adequate flexibility, plasticity and flow characteristics and solubility even after 5 months that defect free sheet could be drawn and solution of rubber in toluene could be obtained. Thus, insulation of composition-4 is fit for insulation lining even after 5 months.

TABLE 6
Mechanical & Interface Properties of Composition -4 tested
1 month after production and 5 months after production

| | Claimed Values of Compositions | | Insulation |
|---|---|---|---|
| | Tested after 1 | Tested after 5 | requirements of |
| Property | month | months | large CRMC |
| Tensile Strength | 124.8-145.3 | 106.5-133.7 | 100 |
| (kg/cm²) | | | (minimum) |
| % Elongation | 687-736 | 688-706 | 600% |
| | | | (minimum) |
| Composite | 6.26-6.99 | 5.66-6.27 | 5.0 (min) |
| (CRMC) - | | | |
| Rubber | | | |
| (kg-f/cm) | | | |
| Rubber - | 4.30-4.88 | 4.52-5.85 | 2.0 (min) |
| Rubber (kg- | | | |
| f/cm) | | | |

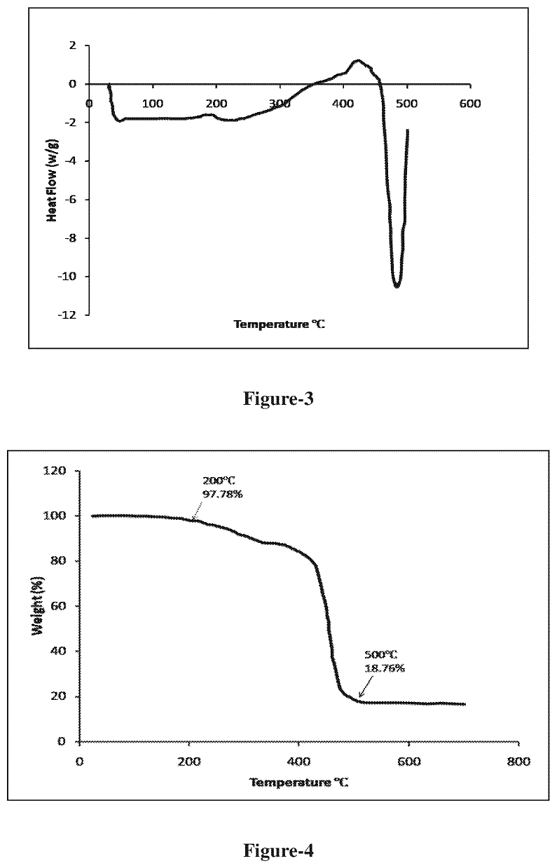

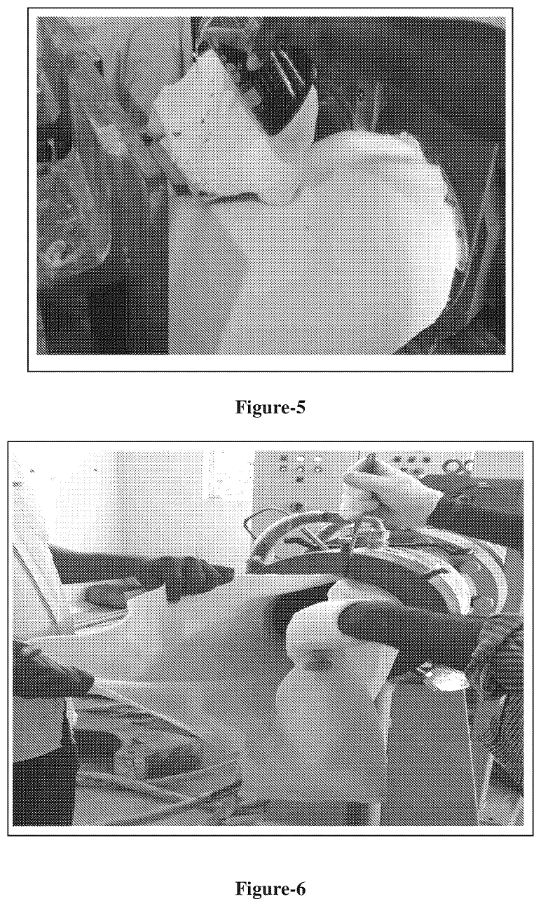

Differential Scanning calorimetry (DSC) and Thermogravimetric Analysis (TGA) plots of Composition-4 are given in FIG. 3 and FIG. 4 respectively. As evident from FIG. 3, peroxide cured EPDM insulation based on Composition-4 is thermally stable up to 420° C. as the final degradation starts thereafter only. As evident from FIG. 4, it is stable up to 400° C.

The rheometer data and mechanical properties of composition-4 when stored at 25° C. is provided below in Table 7 and 8. The results show that composition-4 does not undergo any curing if stored at 25° C. up to 4 months.

TABLE 7
Rheometer data of Composition-4 when stored at 25° C.

| Rheometer carried out | S max (dNm) | S min (dNm) |
|---|---|---|
| @ 140° C./6 hours | (Maximum Torque) | (Minimum Torque) |
| Just after compounding | 15.23 | 1.28 |
| After 1 month of | 15.69 | 1.08 |
| compounding | | |
| After 2.5 months of | 15.84 | 1.38 |
| compounding | | |
| After 4 months of | 15.35 | 1.19 |
| compounding | | |

TABLE 8
Mechanical properties of composition-4 when stored at 25° C.

| | | Moulded & | Moulded & |
|---|---|---|---|
| | | Tested after 3 | Tested after 4 |
| Parameters | Initial value | months | months |
| Shore-A Hardness | 55-60 | 62-64 | 58-62 |
| Tensile | 164 | 151 | 159 |
| Strength(kg/cm²) | (130-198) | (130-169) | (145-167) |
| % Elongation | 661 | 679 | 685 |
| | (619-702) | (656-705) | (675-691) |

The repeatability and reproducibility of all test results was reconfirmed by running two 10 kg production batches and drawing 9.8 meter long, 550-570 mm wide rubber sheet from the blended mass of 20 kg rubber compound. The tested physical, mechanical, thermal and interface properties are given in Table-9:

TABLE 9
Physical, Mechanical, Thermal & Interface properties
of 20 Kg rubber compound prepared using composition-4

| | | |
|---|---|---|
| | | Insulation |
| | Claimed Values of | requirements of |
| Property | Composition | large CRMC |

Physical Properties

| | | |
|---|---|---|
| Shore-A Hardness | 55-60 | For record |
| | | purpose |
| Density (g/cm³) | 0.998-1.000 | As low as |
| | | possible |

Mechanical Properties

| | | |
|---|---|---|
| Tensile Strength (kg/cm²) | 121-202 | 100 kg/cm² |
| | | (minimum) |
| % Elongation | 618-702 | 600% |
| | | (minimum) |

Thermal Properties

| | | |
|---|---|---|
| Thermal conductivity at | 0.196-0.201 | 0.27 |
| 80° C. (W/m-° K) | | (max) |
| Specific Heat at 80° C. | 2.05-2.09 | 1.46 |
| (KJ/Kg-° K) | | (min) |
| Co-efficient of Thermal | 3.0 × 10⁻⁴ | 3.0 × 10⁻⁴ |
| Expansion (/° K) | | (max) |
| Glass Transition | −54 to −55 | As low as |
| Temperature (T_{g}) (° C.) | | possible |
| Erosion rate at 300 W/cm² | 0.12-0.17 | 0.2 |
| heat flux (mm/Sec) | | (Max) |
| Heat of ablation (MJ/Kg) | 17.5-21.1 | 16.0 |
| | | (Min) |

Interface Properties

| | | |
|---|---|---|
| Rubber - Rubber | 5.03-5.21 | 2 |
| (kg-f/cm) | | (min) |
| Propellant to rubber | 1.33-1.80 | 0.6 |
| (kg-f/cm) | | (min) |

Test result of accelerated ageing test & mechanical properties tested after 4 months of compounding are given in Table-10 & 11 below

### Example 3: Comparative Examples (Conventional EPDM Insulation)

Comparative study was performed for evaluating the accelerated ageing and thermal properties of the composition 4 vis-a-vis conventional EPDM insulation (having silica and fibrous filler and sulphur as curing agent).

TABLE 10
Test result of Accelerated ageing of composition-4
in comparison with conventional EPDM insulation

| | | | | Conventional EPDM insulation | | |
|---|---|---|---|---|---|---|
| | | | | (having silica & fibrous filler & | | |
| withdrawal | Composition-4 | | | sulphur as curing agent) | | |
| after | Tensile | | | Tensile | | |
| Accelerated | strength | % | | strength | % | |
| ageing | (kg/cm²) | Elongation | % Change | (kg/cm²) | Elongation | % Change |
| Initial | 147 | 673 | — | 154 | 567 | — |
| | (129-178) | (638-689) | | (138-163) | (553-577) | |
| 90° C./14 | 167 | 650 | Tensile | — | — | — |
| days | (137-205) | (622-681) | Strength: +13.60% | | | |
| | | | Elongation: −3.4% | | | |
| 90° C./21 | 181 | 644 | Tensile | 95 | 355 | Tensile |
| days | (157-199) | (615-664) | Strength: +23.13% | (88-106) | (350-373) | Strength: −38.31% |
| | | | Elongation: −4.3 | | | Elongation: −37.38 |
| 90° C./28 | 175 | 639 | Tensile | 90 | 307 | Tensile |
| days | (164-185) | (625-654) | Strength: +19.04% | (66-106) | (233-350) | Strength: −41.56% |
| | | | Elongation: −5.05 | | | Elongation: −45.85 |

TABLE 11
Comparison of Thermal properties of composition-4
with conventional EPDM insulation

| | | Conventional |
|---|---|---|
| | | EPDM |
| Property | Composition-4 | Insulation |
| Thermal conductivity at | 0.196-0.201 | 0.22 |
| 80° C. (W/m-° K) | | |
| Specific Heat at 80° C. | 2.05-2.09 | 1.84-1.88 |
| (KJ/Kg-° K) | | |
| Co-efficient of Thermal | 3.0 × 10⁻⁴ | 3.0-3.4 × |
| Expansion (/° K) | | 10⁻⁴ |
| Glass Transition | −54 to −55 | −43 |
| Temperature (T_{g}) (° C.) | | |
| Erosion rate at 300 W/cm² | 0.12-0.17 | 0.11-0.17 |
| heat flux (mm/Sec) | | |
| Heat of ablation (MJ/Kg) | 17.5-21.1 | 16.38-22.58 |

From the aforesaid, it is observed that insulation compositions of present invention are technically advanced from the conventional EPDM insulation compositions:
Conventional EPDM formulations fail to achieve a density as low as 0.996 g/cm³. Even, the density of 1.05 g/cm³ and the required mechanical properties have been achieved in conventional formulations by using additional components such as fillers in combination (precipitated silica+zinc oxide, precipitated silica+magnesium hydroxide & precipitated silica+zinc oxide+magnesium hydroxide)·
Conventional EPDM formulations (for e.g. US2018265686A1) involve additional fillers, flame retardants, antioxidants.
The present composition does not use flame retardant; despite that the insulation is flame resistant as it successfully withstood plasma arc jet at a heat flux of 300 W/cm² without catching fire during erosion testing.
The present composition does not use antioxidant; yet, the composition-4 has extremely good ageing resistance as evident from the results of accelerated ageing carried out at 90° C. in comparison with conventional EPDM insulation having precipitated silica & fibrous fillers (Kevlar) & sulphur as curing agent, detailed in Table-10 above.
Further, the insulation compositions including composition-4 of present invention do not undergo any curing if stored at 25° C. up to 4 months; (Reference Rheometer data (Sₘₐₓ & Sₘᵢₙ) given in Table-7 and the tested mechanical properties given in Table-8).
Thermal conductivity is much lower and specific heat capacity at 80° C. is much higher than those of conventional EPDM insulations having precipitated silica & fibrous fillers (Kevlar) & sulphur as curing agent. (Reference: Table-11 gives comparison of thermal properties of composition-4 with conventional EPDM insulation).
Maximum tensile strength of Composition-4 is 164.7 kg/cm² while retaining minimum % Elongation of 606 (600 minimum required). On the other hand, Maximum Tensile strength in composition F of US2018265686A1 is 2010 psi or 141.317 kg/cm² and the achieved % elongation is just 415, which is much lower than the minimum required 600% elongation for our requirements. The composition which has given the highest % elongation of 988 gives a tensile strength of just 1230 psi or 86.40 kg/cm². Which is even lower than the minimum claimed tensile strength of 131.7 kg/cm² of composition-4
Further, none of the literature on peroxide cured EPDM insulation provides the homogeneity achieved on the sheet drawn. Achieving homogeneity (uniform mechanical & thermal properties anywhere, any direction of 9.8 meter long 550-570 mm wide sheet drawn out of 20 kg peroxide cured EPDM based insulation compound) is yet another achievement of the present invention. Several hardships have been faced by the inventors to reach this level of homogeneity. For example, in one of the initial trials with 4 kg compound, the achieved tensile strength was as low as 64 kg/cm² and as high as 162 kg/cm² on the sheet drawn. Uniform/homogeneous dispersion of polar peroxide (in crystalline state) over apolar (non-polar) EPDM matrix is the greatest challenge posed by peroxide curing technology in case of EPDM based insulation. Moreover, discoloration at discrete locations due to presence of peroxide is yet another challenge. Uniform dispersion of peroxide in the present invention has helped to achieve uniform mechanical properties and smooth surface of sheet drawn without any discolored patches.
Further, achieving a low density of 0.996 g/cm³ with the conventional ingredients without compromising on the insulation requirements including ablative characteristics/erosion resistance shows the technical advancement of present invention. This is possible only when effective filler to rubber interaction and required extent of crosslinking are synergistically achieved. The same has been successfully demonstrated in the present invention. Any shift in the synergy between filler to rubber interaction and degree of crosslinking might render the insulation unacceptable for the given end application.
The present invention has rendered insulation with exceptional shelf life in uncured condition and extremely good ageing resistance.

It is to be understood that the present invention is susceptible to modifications, changes and adaptations by those skilled in the art. Such modifications, changes, adaptations are intended to be within the scope of the present invention.

1. An elastomeric rubber insulation composition for composite rocket motor casing (CRMC) comprising:
(i) Solid ethylene propylene diene terpolymer (EPDM) rubber ranging from 80 to 95 phr;
(ii) Liquid EPDM rubber ranging from 5 to 20 phr;
(iii) Precipitated silica filler ranging from 20 to 50 phr;
(iv) Peroxide curing agent ranging from 1 to 10 phr and;
(v) Additives.

2. The composition as claimed in claim 1, wherein the precipitated silica filler ranges from 20 to 26 phr in Composition-4.

3. The composition as claimed in claim 1, wherein the peroxide curing agent is selected from Dicumyl Peroxide (DCP), di-tert-butyl-peroxide (DTBP), 1,1-di-(t-butylperoxy)-3,3,5-trimethylcyclohexane and 1,1-di-(t-butylperoxy)-3,3,5-trimethylcyclohexane.

4. The composition as claimed in claim 1, wherein the additives are selected from 5 to 25 phr process oil, 5 to 25 phr Aromatic polyether based tackifier, 1 to 5 phr plasticizer and process aids, 0.5 to 5 pigment and 2 to 6 phr curing co-agents.

5. The composition as claimed in claim 4, wherein the process oil is selected from Naphthenic Oil.

6. The composition as claimed in claim 4, wherein the tackifier is selected from Aromatic polyether, wingtack-95, Vulcanol FH, aliphatic resin and the like.

7. The composition as claimed in claim 4, wherein the Plasticizer and Process aids are selected from Polyethylene glycol (PEG), Di-octyl Phthalate (DOP), Diethylene Glycol (DEG), Stearic Acid and the like.

8. The composition as claimed in claim 4, wherein the pigment is selected from titanium dioxide (TiO₂).

9. The composition as claimed in claim 4, wherein the curing co-agents are selected from Zinc Dimethacrylate (ZDMA) trimethylolpropane trimethacrylate, high vinyl poly (butadiene).

10. The composition as claimed in any one of the claims 1 to 9, wherein density ranges from 0.996 to 1.055 g/cm³.

11. The composition as claimed in any one of the claims 1 to 10, wherein said composition is free of fibrous fillers and non-EPDM polymers.

12. A composite rocket motor casing (CRMC) composed of an elastomeric rubber insulation composition as claimed in any one of claims 1 to 11.

13. A process for preparing an elastomeric rubber insulation composition comprising the steps of:
I. Pre-mixing the components of solid EPDM, liquid EPDM, precipitated silica filler, process oil, a portion of Aromatic polyether based tackifier, Plasticizer & Process aids, and pigment;
II. Final mixing of the rubber mass obtained at step (I) with a dissolved solution of peroxide curing agent, curing co-agent and the remaining portion of tackifier;
III. Curing the rubber mixture of step (II) at 140-150° C. to obtain the elastomeric rubber insulation composition
Wherein the ratio of tackifier added at step (I) premixing to Step (II) final mixing is about 70:30 by weight.
